(19) United States
(12) Patent Application Publication
(10) Pub. No.: US 2017/0022696 A1
(43) Pub. Date: Jan. 26, 2017

(54) INCREASED CAPTURE STORM DRAIN SCREENS

(71) Applicant: Bio Clean Environmental Services, Inc., Oceanside, CA (US)

(72) Inventor: Ernest Jarvis, Norco, CA (US)

(21) Appl. No.: 15/188,880

(22) Filed: Jun. 21, 2016

Related U.S. Application Data
(60) Provisional application No. 62/182,611, filed on Jun. 21, 2015.

(51) Int. Cl. E03F 5/04; B01D 29/44

(52) U.S. Cl. CPC E03F 5/0404; B01D 29/445

(57) ABSTRACT

Embodiments of the present invention provide a first storm drain inlet screen, configured for installation in a storm drain inlet opening. The first storm drain inlet screen possesses a front screen, a plurality of front screen perforations, and a plurality of particulate matter capture bars. In such embodiments, the particulate matter capture bars: are fixedly attached to the front screen, traverse at least ¼ of the front screen perforations, reduce, by less than 5%, an amount by which the front screen perforations, in aggregate, render open a total frontward surface area of the front screen, and are operative to increase by at least 50% an amount of particulate matter captured outside of a storm drain into which the first storm drain inlet screen is installed, as compared to a second storm drain inlet screen that differs from the first inlet screen by entirely lacking particulate matter capture bars.

### CROSS REFERENCE TO RELATED APPLICATIONS

This application claims benefit to U.S. Provisional Application 62/182,611, entitled “INCREASED CAPTURE STORM DRAIN SCREENS,” filed on Jun. 21, 2015, the entirety of which is hereby incorporated by reference herein.

### BACKGROUND

Technical Field

This disclosure relates generally to storm water filtration systems, and more particularly to storm drain screens capturing particulate matter and/or debris from storm water runoff.

Related Art

Primary functions of storm water conveyance systems include the prevention of erosion and flooding by channeling surface water runoff into networks of underground pipes and/or open channels for controlled distribution. Surface water runoff taken into storm water conveyance systems can be directed to water treatment facilities and/or open bodies of water, such as rivers, lakes, and oceans. Storm drains represent the intake point of surface water runoffs into the storm water conveyance system.

Particulate matter and/or debris removal is an important function of storm drain filtration systems because such debris entering storm drains along with surface water runoff may clog storm drains, resulting in flooding, or run through storm drains, resulting in damage to water treatment facilities and/or pollution of receiving water bodies. Storm drains can incorporate a variety of filter systems designed to reduce the amount of debris that enters the storm drain and/or the storm water conveyance system.

### SUMMARY

Surface water runoff can enter a storm drain through openings called storm drain inlets. Storm drain inlets can allow water to run into a catch basin. The catch basin can have an intake opening and an outlet pipe that provides a path for water to run from the catch basin into the remainder of the storm water conveyance system.

While storm drain filtration systems should inhibit debris and trash from entering into the storm drain and/or storm water conveyance system, they should not interfere with the primary functions of the conveyance system, which is the prevention of erosion and flooding. One strategy for achieving these objectives are storm drain filtration systems comprising screens that occupy a closed position under dry conditions, or conditions of low or moderate water flow, and an open position under conditions of moderate to heavy water flow. In such systems, screens in the closed position impede the passage of debris while permitting low to moderate water flow; and screens in the open position allow the passage of debris and water such that the screens themselves do not plug the storm drains and cause flooding.

In the context of curb inlet filtration units, debris detained by such screens when there is no, low, or moderate water flow can be removed by a street sweeper, keeping the removed debris out the storm drain and the storm water conveyance system. In the context of connector pipe filtration units, debris detained by such screens when there is no, low, or moderate water flow can be removed from the storm drain catch basin by maintenance crews, keeping the removed debris out of the remainder of the storm drain and/or storm water conveyance system.

Embodiments of the disclosure provide a first storm drain inlet screen, configured for installation in a storm drain inlet opening. The first storm drain inlet screen possesses a front screen, a plurality of front screen perforations, and a plurality of particulate matter capture bars. In such embodiments, the particulate matter capture bars: are fixedly attached to the front screen, traverse at least ¼ of the front screen perforations, reduce, by less than 5%, an amount by which the front screen perforations, in aggregate, render open a total frontward surface area of the front screen, and are operative to increase by at least 50% an amount of particulate matter captured outside of a storm drain into which the first storm drain inlet screen is installed, as compared to a second storm drain inlet screen that differs from the first inlet screen by lacking particulate matter capture bars.

In some embodiments, the front screen and the particulate matter capture bars are made of steel, stainless steel, or a combination thereof. In some embodiments, at least a portion of the front screen perforations possess a shape selected from the group consisting of circular, oval, triangular, rectangular, and square. In some embodiments, the front screen perforations and the particulate matter capture bars are formed by cutting a single sheet of metal. In some embodiments, the particulate matter capture bars horizontally bisect the front screen perforations.

As used herein, the term “frontward” refers to the side of a resistance screen or a component of a resistance screen from which water that passes through it approaches.

An aspect of this disclosure provides a first storm drain inlet screen. The first storm drain inlet screen can be installed in a storm drain inlet opening. The first storm drain inlet screen can have a front screen, a plurality of front screen perforations, and a plurality of particulate matter capture bars. The plurality of particulate matter capture bars can be fixedly attached to the front screen. The plurality of particulate matter capture bars can traverse at least ¼ of the front screen perforations. The plurality of particulate matter capture bars can reduce an amount by which the front screen perforations, in aggregate, render open a total frontward surface area of the front screen by less than 5 percent. The plurality of particulate matter capture bars can increase by at least 50 percent an amount of particulate matter captured outside of a storm drain into which the first storm drain inlet screen is installed, as compared to a second storm drain inlet screen that differs from the first inlet screen by entirely lacking particulate matter capture bars.

Another aspect of the disclosure provides a device for storm water filtration. The device can have a front screen. The front screen can have a pair of hanging pivots. The hanging pivots can mount the device within a curb drain inlet. The device can also have a plurality of perforations formed in the front screen. Each perforation of the plurality of perforations can have a diameter of approximately three quarters of an inch. The plurality of perforations can be evenly spaced across the front screen. The device can also have a plurality of particulate matter capture bars traversing at least a portion of the plurality of perforations.

### BRIEF DESCRIPTION OF THE DRAWINGS

FIG. 1 is a perspective view of a prior art storm drain curb inlet screen.

FIG. 2 is a perspective view of a storm drain curb inlet screen of the invention.

FIG. 3 is a perspective view of a storm drain curb inlet screen of the invention installed in a curb inlet opening of a storm drain.

FIG. 4 is a perspective view of a storm drain curb inlet screen of the invention.

FIG. 5 is a perspective view of a storm drain curb inlet screen of the invention.

### DETAILED DESCRIPTION

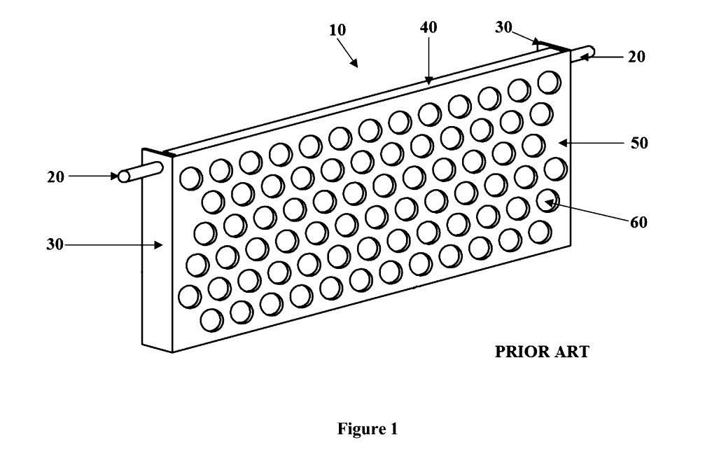

FIG. 1 is a front elevation view of a prior art storm drain curb inlet screen 10 that comprises hanging pivots 20, side plates 30, top plate 40, front screen 50, and front screen perforations 60. Prior art curb inlet screen 10 is made of metal, such as steel or stainless steel. The circular front screen perforations 60 of typical prior art curb inlet screen 10 are substantially evenly spaced on the front screen 50, possess a three-quarter (¾) inch diameter, and in aggregate render open approximately 50% of the curb inlet front screen's 50 frontward surface area.

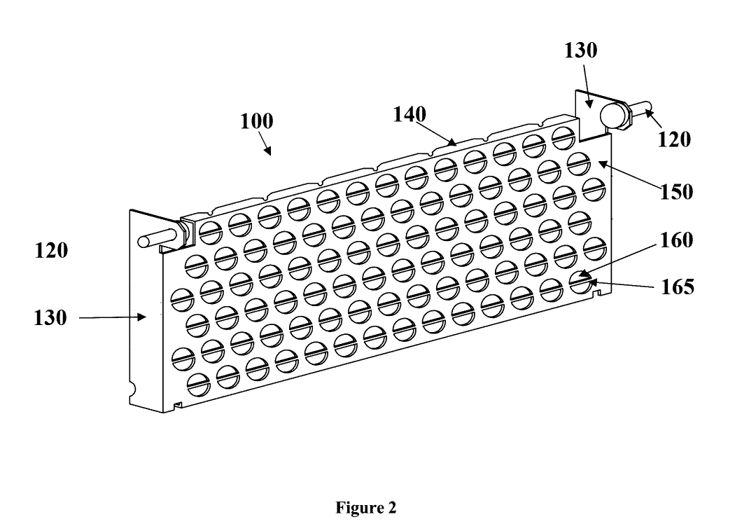

FIG. 2 is a front elevation view of an embodiment of a storm curb drain inlet filter 100 having hanging pivots 120, side plates 130, a top plate 140, a front screen 150, and a plurality front screen perforations 160. The hanging pivots 120 can allow storm the curb drain inlet filter 100 to be installed into the opening of a storm drain. The circular front screen perforations 160 of curb inlet screen 100 are substantially evenly spaced on front screen 150. The screen perforations 160 can have a ¾ inch diameter. The screen perforations 160 can also be divided by particulate matter capture bars 165. In some embodiments, the particulate matter capture bars 165 can bisect the screen perforations 160. In some embodiments, the particulate matter capture bars 165 horizontally bisect the front screen perforations 160. The particulate matter capture bars 165 can be rigid, sturdy, and made of a variety of metallic materials, such as steel or stainless steel. The particulate matter capture bars 165 can be sized and dimensioned such that, in combination with circular front screen perforations 160, approximately 46% of the curb inlet front screen's 150 frontward surface area is open.

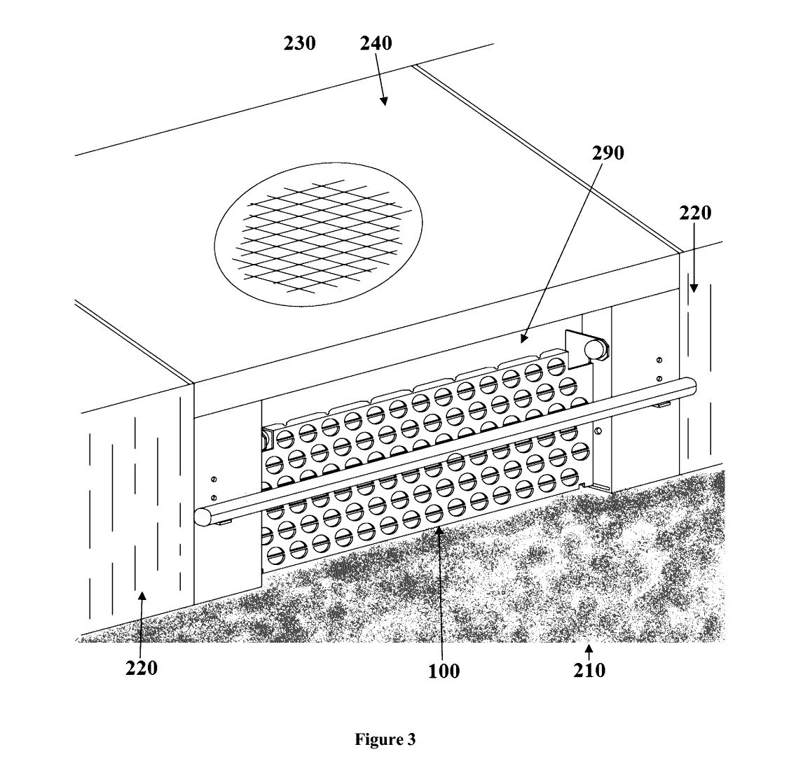

FIG. 3 is an elevated view of a sidewalk 240 with a storm drain manhole cover 230 and a curb 220 bordering roadway 210. A storm drain inlet opening 290 in the curb 220 can be partially occupied by the storm drain curb inlet screen 100 illustrated in FIG. 2. The storm drain curb inlet screen 100 can capture outside of storm drain opening 290 (i.e., in the roadway 210) significant amounts of particulate matter and debris that would pass through storm drain opening 290 in surface water runoff or wind currents or other means, in the absence of storm drain curb inlet screen 100.

The front screen perforations 160 and the particulate matter capture bars 165 in the front screen 150 of the storm drain curb inlet screen 100 illustrated in FIG. 2, as well as in other embodiments of the invention, can be formed by cutting a sheet of metal. Exemplary cutting techniques include, without limitation, sawing performed with a rotary saw, hack saw, band saw, or the like; flame cutting performed with an oxygen-acetylene (or related fuel) torch; plasma cutting; laser cutting; and shearing performed with a mechanical press.

Storm drain curb inlet screens of the disclosure having front screen perforations (e.g., the front screen perforations 160) having particulate matter capture bars can also be formed by first making perforations in the front screen and then fixedly attaching to the front screen particulate matter capture bars in a manner that bisects the perforations. The front screen perforations 160 can be formed by any suitable technique, such as drilling or cutting. The particulate matter capture bars 165 can be fixedly attached to the front screen by any suitable technique, such as welding, riveting, bolting, screwing, or gluing. Such attachment techniques can also be employed to retrofit existing, prior art curb inlet screens that lack particulate matter capture bars with the same to transform them into curb inlet screens.

Particulate matter capture bars can be made of metal, such as steel and stainless steel, plastic, wood, rope, thread, twine, and combinations thereof.

Front screen perforations of the present invention can comprise a variety of shapes, such as circular, oval, triangular, square, diamond, rectangular, pentagonal, hexagonal, heptagonal, nonagonal, decagonal, hendecagonal, dodecagonal, tridecagonal, tetradecagonal, pentadecagonal, and the like. Front screen perforations of the present invention can comprise a variety of widths or diameters, such as about ¾ inch, ⅔ inch, ½ inch, ⅓ inch, ¼ inch, or ⅛ inch. In addition, a single front screen of the invention can possess a plurality of disparately shaped and sized front screen perforations.

Particulate matter capture bars of the invention can also comprise a variety of forms and shapes, such as bars, pins, sticks, and shafts and tubular, triangular, square, rectangular, pentagonal, hexagonal, heptagonal, nonagonal, decagonal, hendecagonal, dodecagonal, tridecagonal, tetradecagonal, pentadecagonal, and the like. In addition, a single front screen of the invention can possess disparately formed and/or shaped particulate matter capture bars. Particulate matter capture bars of the invention can be unthreaded or threaded, in whole or in part.

Particulate matter capture bars of the invention can be fixedly attached to front screens such that they bisect front screen perforations, or such that they are offset from bisecting front screen perforations by about 10%, 20%, 30%, 40%, 50%, or 60%. In addition, a single front screen of the invention can possess one or more perforation(s) bisected by particulate matter capture bars and one or more perforation(s) having particulate member capture bars offset from bisecting.

In some embodiments, a single particulate matter capture bar can span a plurality of front screen perforations, such as two, three, four, five, six, seven, eight, nine, ten, eleven, twelve, thirteen, fourteen, fifteen, and the like. In some embodiments, particulate matter capture bar(s) horizontally traverse front screen perforations. In some embodiments, particulate matter capture bar(s) can vertically traverse the front screen perforations 160. In some embodiments, particulate matter capture bar(s) traverse front screen perforations at an angle offset from horizontal by about plus or minus 10°, 20°, 30°, 40°, 50°, 60°, 70° or 80°. In some embodiments, the perforations of a single front screen are traversed by particulate member capture bars having different offsets relative to horizontal. In some embodiments, a fraction of the total number of perforations in a single front screen are traversed by particulate matter capture bars such as about 15/16, ¾, ⅔, ½, ⅓, ¼, or ⅛.

Certain embodiments can provide storm drain curb inlet screens having front screens (e.g., the front screen 150) having front screen perforations (e.g., the front screen perforations 160) traversed by particulate matter capture bars. The front screen perforations can, in aggregate and in the absence of the particulate matter capture bars, render open about 20% to about 80% of the total frontward surface area of a front screen, such as about 20% open, 30% open, 40% open, 50% open, 60% open, 70% open, and 80% open.

The particulate matter capture bars 165 only modestly reduce, by about 1% to about 15%, such as about 1%, 2%, 4%, 6%, 8%, 10%, 12%, or 15%, the amount by which front screen perforations render open the total frontward surface area of a front screen according to the invention. In view of the modest reductions in percentages of open front screen surface areas caused by particulate matter capture bars, particulate matter capture bars of the invention effect surprisingly and unexpectedly large increases in particulate matter capture outside storm drain inlet screens of the invention, as compared to prior art storm drain inlet screens. Such increases in particulate matter and debris captured outside storm drain inlet screens of the invention, as compared to prior art storm drain inlet screens that lack particulate matter capture bars, can be about 30%, 40%, 50%, 60%, 70%, 80%, 90%, 100%, 125%, 150%, 175%, 200%, 300%, 400%, 500%, or more.

The types of particulate matter and/or debris subject to increased capture outside of storm drain openings by storm drain curb inlet screens of the invention include, without limitation, rocks, sticks, mulch, leaves, nuts, bolts, bottle caps, wine bottle corks, coins, cigarettes, cigarette butts, straws, forks, knives, spoons, and the like.

In some embodiments, parts of curb inlet screen 100 (of e.g., FIG. 2 and FIG. 3) can be formed of various metallic materials, such as steel or stainless steel. In some embodiments, the weight of the front screen 150 and/or of the particulate matter capture bars 165 can shift a center of gravity of the front screen 150 such that the curb drain inlet filter 100 as a whole is biased toward a closed position, for example, toward the roadway 210.

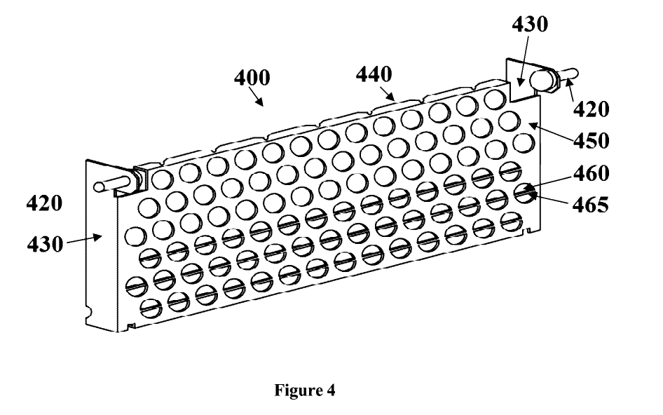

FIG. 4 is a perspective view of an embodiment of a storm drain curb inlet screen 400 according to the present that comprises hanging pivots 420, side plates 430, top plate 440, front screen 450, and front screen perforations 460. Hanging pivots 420 can allow storm drain curb inlet filter 400 to be installed into the opening of a storm drain. The circular front screen perforations 460 of curb inlet screen 400 are substantially evenly spaced on the front screen 450 and have a ¾ inch diameter. In some embodiments, approximately one half of the front screen perforations 460 are bisected by particulate matter capture bars 165. The particulate matter capture bars 465 can horizontally bisect front screen perforations 460. The particulate matter capture bars 465 can be rigid, sturdy, and made of metal, such as steel or stainless steel. The particulate matter capture bars 465 are sized and dimensioned such that, in combination with circular front screen perforations 460, approximately 48% of the curb inlet front screen's 450 frontward surface area is open.

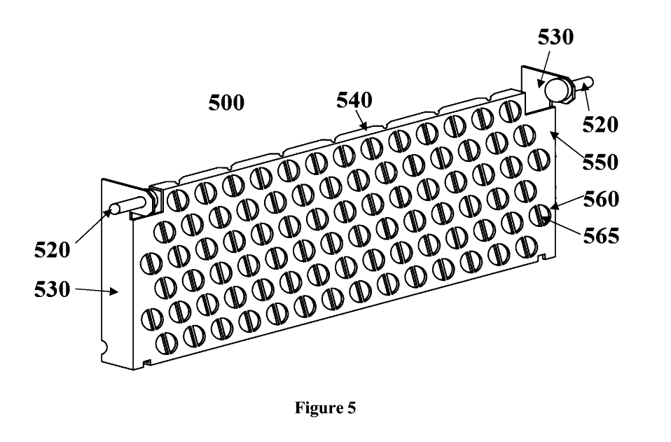

FIG. 5 is a perspective view of an embodiment of a storm drain curb inlet screen 500 according to the present that comprises hanging pivots 520, side plates 530, top plate 540, front screen 550, and front screen perforations 560. Hanging pivots 520 can allow storm drain curb inlet filter 500 to be installed into the opening of a storm drain. The circular front screen perforations 560 of curb inlet screen 500 are substantially evenly spaced on front screen 550 and possess a ¾ inch diameter. Approximately one half of the front screen perforations 560 are bisected by particulate matter capture bars 565. Particulate matter capture bars 565 can bisect front screen perforations 560 at an angle of approximately minus 10° from vertical. The particulate matter capture bars 565 can be rigid, sturdy, and made of various metallic materials, such as steel or stainless steel. Particulate matter capture bars 565 are sized and dimensioned such that, in combination with circular front screen perforations 560, approximately 46% of the curb inlet front screen's 550 frontward surface area is open.

One of ordinary skill will recognize the interchangeability of various features from different embodiments. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific embodiments described herein.

What is claimed is:

1. A first storm drain inlet screen, configured for installation in a storm drain inlet opening, the first storm drain inlet screen comprising a front screen, a plurality of front screen perforations, and a plurality of particulate matter capture bars, wherein the particulate matter capture bars are:
fixedly attached to the front screen;
traverse at least ¼ of the front screen perforations;
reduce an amount by which the front screen perforations, in aggregate, render open a total frontward surface area of the front screen by less than 5 percent; and
operative to increase by at least 50 percent an amount of particulate matter captured outside of a storm drain into which the first storm drain inlet screen is installed, as compared to a second storm drain inlet screen that differs from the first inlet screen by entirely lacking particulate matter capture bars.

2. The first storm drain inlet screen of claim 1, wherein the front screen and the particulate matter capture bars are made of steel, stainless steel, or a combination thereof.

3. The first storm drain inlet screen of claim 1, wherein at least a portion of the front screen perforations possess a shape selected from the group consisting of circular, oval, triangular, rectangular, and square.

4. The first storm drain inlet screen of claim 1, wherein the front screen perforations and the particulate matter capture bars are formed by cutting a single sheet of metal.

5. The first storm drain inlet screen of claim 1, wherein the particulate matter capture bars horizontally bisect the front screen perforations.

6. A device for storm water filtration, comprising:
a front screen having a pair of hanging pivots operable to mount the device in a curb drain inlet;
a plurality of perforations formed in the front screen, each perforation of the plurality of perforations having a diameter of approximately three quarters of an inch and evenly spaced across the front screen; and
a plurality of particulate matter capture bars traversing at least a portion of the plurality of perforations.
